(19) United States
(12) Patent Application Publication
(10) Pub. No.: US 2010/0025169 A1
(43) Pub. Date: Feb. 4, 2010

(54) Brake disk for a disk brake

(75) Inventor: Reiner Becker, Rabenau (DE)

Correspondence Address: PROSKAUER ROSE LLP, ONE INTERNATIONAL PLACE, BOSTON, MA, 02110, US

(73) Assignee: Fritz Winter Eisengiesserei GmbH & Co. KG, Stadtallendorf (DE)

(21) Appl. No.: 12/521,852

(22) PCT Filed: Jan. 4, 2008
(86) PCT No.: PCT/EP08/50071

§ 371 Date: Aug. 20, 2009

(30) Foreign Application Priority Data
Jan. 10, 2007 (DE) 10 2007 001 567.6

(51) Int. Cl. F16D 65/12

(52) U.S. Cl. 188/218 XL

(57) ABSTRACT

A brake disk for a disk brake includes a friction ring as first connection partner and a carrier part as second connection partner, wherein the connection partners are connected to one another for co-rotation by radially-oriented projections, which are formed as single pieces onto one of the connection partners and engage in positive fit in correspondingly shaped cut-out apertures of the respective other connection partner. The brake disk according to the invention can be manufactured cheaply, guarantees high operational reliability, and at the same time has optimized behavior under the influence of the heat which is unavoidably generated during a braking procedure. This is achieved in that at least one of the projections has a passage channel, and in that at least one ventilation channel is formed in the friction ring for conducting away ambient air or for introducing ambient air into the passage channel of the individual projection.

### CROSS-REFERENCE TO RELATED APPLICATIONS

This application is a National Phase Application of International Application No. PCT/EP2008/050071, filed on Jan. 4, 2008, which claims the benefit of and priority to German patent application no. DE 10 2007 001 567.6-12, filed on Jan. 1, 2007. The disclosures of the above applications are incorporated herein by reference in their entirety.

### FIELD OF THE INVENTION

The invention relates to a brake disk for a disk brake, intended in particular for use on motor vehicles, and equipped with a friction ring as first connection partner and a carrier part as second connection partner, wherein the connection partners are connected to one another for co-rotation by radially-oriented projections, which are formed as single pieces onto one of the connection partners and engage in positive fit in correspondingly shaped cut-out apertures of the respective other connection partner.

### BACKGROUND

Brake disks of the type referred to are known, for example, from DE 100 60 262 A1 or WO 2006/046258 A1. The essentially purely positive fit connection provided with these brake disks between the carrier part and the friction ring by way of the “projection/cut-out” connection elements allows for the expansion of the friction ring in the event of heating, which occurs during the braking process as a consequence of the conversion of kinetic energy into friction.

The expansion of the friction ring in the radial direction can be achieved on the one hand due to the fact that trunnion-type projections are cast onto the carrier part, protruding from the carrier part in a radial direction, which engage in positive fit in correspondingly shaped cut-outs of the friction ring. Likewise, however, it is also possible, in the sense of a kinematic inversion of this possibility, for corresponding trunnions to be cast onto the friction ring, which engage in corresponding cut-outs on the carrier part.

The side surfaces of the brake disk usually serve as friction surfaces for the brake linings of the disk brake, which are pressed under high pressure against the friction ring. The carrier part, by contrast, provides the connection to the brake element to be braked in each case, for example to the respective wheel of a car or lorry.

Disk brake systems equipped with brake disks of the type referred to above are used in particular in high-performance passenger cars or utility vehicles, in which, in the course of a braking procedure, high kinetic energy values must be converted into friction heat. The heating effect which is therefore inevitably associated with the braking procedure and the dissipating of heat, as a rule only possible to a limited degree due to restrictions in dimensions and weight, lead to the situation in which the friction rings become very hot, with the consequence that they expand to a correspondingly high degree. Because the friction ring is connected to the carrier part in such a way that it can expand in the radial direction essentially unhindered, independently of the carrier part, in consequence the risk of the occurrence of cracks is minimized, which can otherwise occur due to the high inner stresses which arise when the friction ring is heated.

A further advantage of brake disks of the type in question is that they can be produced with relatively low effort and expenditure in terms of casting technology. Thus, for example, the friction ring can be prefabricated by casting technology with the projections formed on it and machined subsequently with the removal of material if so required. The carrier part can then be cast onto the friction ring. As casting material for the friction ring, cast iron has proved its worth, which is capable of withstanding high thermal and mechanical stress loadings.

By contrast, if the carrier part is made of aluminum substantial weight savings can be achieved (WO 2006/046258 A1).

In order to improve the precision of the connection between the friction ring and the carrier part with brake disks of the type in question, it has been proposed, for example in DE 102 27 529 A1, that bolts be cast into the carrier part, projecting from it in the radial direction, which engage with their free end sections into cut-outs formed in the friction ring. In this situation, a sleeve is cast into each of the cut-outs in which the end section of the bolt allocated to it is located, movable in the radial direction of the respective brake disk. Practical experience has shown, however, that the expenditure associated with the manufacture of such brake disks is considerable. Such brake disks can accordingly only be offered at a very high price.

### SUMMARY OF THE INVENTION

Against the background of the foregoing summarized prior art, an aspect of the invention is to create a brake disk which can be manufactured economically, guarantees high operational reliability, and at the same time has optimized behavior under the influence of the heat unavoidably produced during a braking procedure.

A brake disk according to an embodiment of the invention includes a friction ring as a first connection partner and a carrier part as a second connection partner, wherein the first and second connection partners are connected to one another for co-rotation by radially-oriented projections, which are formed as single pieces onto one of the first and second connection partners (e.g., friction ring, carrier part) and engage in positive fit in correspondingly shaped cut-out apertures of the respective other connection partner (e.g., carrier part, friction ring). In accordance with this embodiment of the invention, at least one of the radially-oriented projections has a passage channel, and at least one ventilation channel is formed in the friction ring for conducting away ambient air or for introducing ambient air into the passage channel of the at least one radially-oriented projections.

The invention assumes, as with the prior art, that projections are cast onto the friction ring or the carrier part. Then, as with the prior art, by means of projections engaging in corresponding cut-outs of the other connection partner in each case, the “carrier part”/“friction ring”, an as far as possible purely positive-fit coupling of friction ring and carrier part is effected, by means of which the friction ring can expand essentially unhindered in the radial direction when it becomes heated.

In comparison with conventionally designed brake disks, a brake disk according to the invention is characterized in that a passage channel is formed in at least one of the projections, wherein a ventilation channel is present in the friction ring itself, by means of which air flowing in via the individual passage channels in the projections is conducted away, or by means of which air can pass into the individual passage channel.

In the event of the projections being assigned to the friction ring, the passage channel formed in the projections can merge free of interruption into the ventilation channel provided in the friction ring. The ventilation channel present in the friction ring then represents a simple extension of the passage channel of the individual projection.

With a brake disk according to the invention, cooling air can consequently also flow through the areas in which the carrier part and friction ring are directly coupled to one another. As a result, in the areas of the brake disk according to the invention which in practical operation are subjected to particularly high stress, a constant dispersion of excess heat is therefore assured and the risk of stress cracks as a consequence of overheating is minimized accordingly.

At the same time, a brake disk according to the invention can also be manufactured in a simple manner in terms of casting technology, since the individual projections can be cast in one procedure with the individual friction ring or carrier part. Due to the single-piece connection between the projections and the individual connection partner, it is further ensured that the coupling of friction ring and carrier part will remain permanently maintained even under unfavorable operating conditions.

A variant, particularly well-suited to actual practice, of a brake disk according to the invention is characterized in that the projections are formed onto the friction ring. The allocation of the projections to the friction ring favors on the one hand the unimpeded radial expansion of the friction ring when it becomes heated. On the other hand, with this arrangement the carrier part can be manufactured without any problem in terms of casting technology from a material which melts at perceptibly lower temperatures than the material of the friction ring. Accordingly, the allocation of the projections to the friction ring proves to be particularly favorable if the carrier part consists of aluminum and the friction ring of cast iron material.

An optimized cooling effect can be achieved with a brake disk according to the invention if each of the projections has a passage channel.

In order to ensure a particularly good ventilation of the passage channels present in each case, it is advantageous if the cut-outs of the carrier part which are allocated to the projections provided with the passage channels have at least one aperture for the conducting of ambient air, which is connected to the passage channel of the projections.

As an alternative or supplement to this, it has proved advantageous if the cut-outs of the carrier part which are allocated to the projections provided with passage channels are formed as break-throughs. This arrangement allows the projections to be guided through the cut-outs, such that, with an appropriate arrangement of the mouth aperture of the individual passage channel, the ambient air can flow into the passage channel and out again largely unimpeded. For this purpose, the free length of at least the projections provided with the passage channels should be dimensioned in such a way that the projections concerned engage through the cut-outs. With regard to the air intake and outlet aimed for, it is advantageous in this situation if the opening of the individual passage channel allocated to the carrier part, arranged on the free face side of the projections, is arranged flush with the opening of the cut-out facing away from the friction ring, or even projects over it.

In terms of casting technology, the projections of a brake disk according to the invention can be manufactured particularly well if they have a circular cross-section shape, in the manner of bolt-type trunnions. Increased resistance to the mechanical loads arising during a braking procedure can be achieved, however, if the projections have an elliptical cross-section.

With a simple design of the brake disk according to the invention, the uniformity of the heat dissipation can be favored if the individual passage channels of the projections are arranged coaxially to the longitudinal axis of the projections.

The exactness of the guidance of the projections into the cut-outs individually allocated to them can, if required, be further improved if the projections have at their free end section a shoulder with a circumferential surface machined with the removal of material. By means of such a shoulder, produced by subsequent machining after the casting of the connection partner provided in each case with the projections, a particularly precise positive-fit guidance of the projections in the cut-outs allocated to them can be achieved.

The latter situation applies in particular if the cut-outs are surrounded in each case by a sleeve, which is cast into the connection partner which has the cut-outs. By way of such a sleeve it can be ensured not only that the surfaces of the brake disk coming in contact with one another in positive fit are perfectly geometrically aligned, but also that the sleeve can also serve to provide the carrier part with the loading resistance required in the area of the cut-outs.

This applies in particular in cases in which the carrier part is manufactured from a material of lesser strength but in compensation light in weight, such as a light metal alloy, in particular aluminum.

In technical manufacturing terms, a brake disk according to the invention, of which the friction ring consists of cast iron and the carrier part of an aluminum cast material, can be produced particularly simply if in the first instance the friction ring is cast with the projections provided with passage channels formed on it and next the projections of the friction ring are machined at their free ends in such a way that a shoulder is formed at that point, the outer diameter of which corresponds to the inner diameter of the sleeve surrounding the cut-out allocated to it in each case with the finished brake disk, then the sleeve concerned is placed on the shoulder of the individual projection and finally the carrier part is cast onto the friction ring in a suitable casting mold, wherein the aluminum of the carrier part surrounds the sleeves at their circumference, such that they are held in the carrier part in positive or negative fit and/or by integral joining, and at the same time form cut-outs formed in the manner of break-throughs, in which the projection allocated in each case is exactly guided.

With the invention, therefore, an internally-vented brake disk is provided which can be manufactured with little expenditure and effort in terms of casting technology, and in which, due to the floating bearing of the friction ring on the carrier part, low thermal stresses are incurred during a braking procedure, such that the inclination to form cracks is perceptibly reduced. The passage apertures introduced into the projections in this situation ensure improved venting in comparison with the known compound casting designs and a correspondingly reduced temperature level during the braking procedure. The low thermal stresses which arise with a brake disk according to the invention, in conjunction with the reduced temperature level, allow a reduction in the thermally active friction ring mass, such that the weight of a brake disk according to the invention is further reduced overall in comparison with conventional disks of this type. This applies in particular if the carrier part is manufactured from a light metal material, in particular an Al-material.

### BRIEF DESCRIPTION OF THE DRAWINGS

The invention is described in greater detail hereinafter on the basis of a drawing representing an embodiment. The figures show, in diagrammatic form:

FIG. 1 A brake disk in a side view;

FIG. 2 The friction ring of the brake disk represented in FIG. 1, in a section along the sectional line X-X shown in FIG. 1;

FIG. 3 A section from the brake disk represented in FIG. 1, in a section along the sectional line X-X shown in FIG. 1;

FIG. 4 A section from the brake disk represented in FIG. 1, in a section along the sectional line Y-Y shown in FIG. 1.

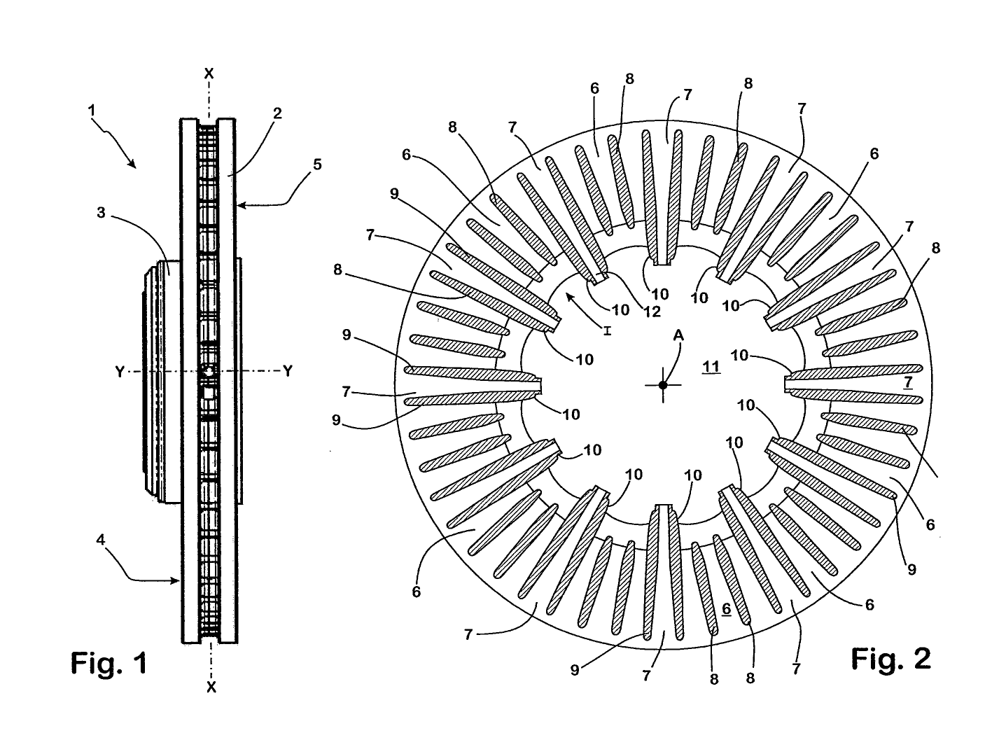

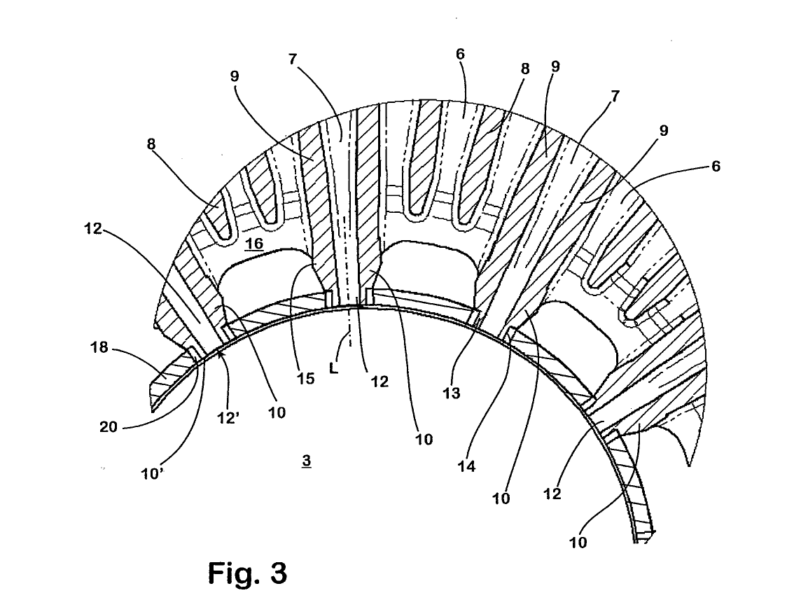

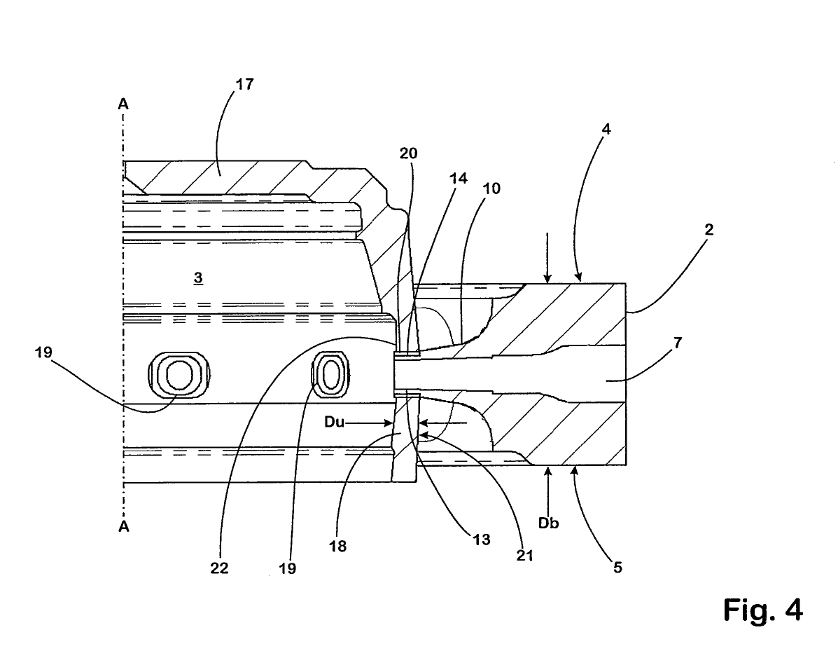

### DETAILED DESCRIPTION

The internally-vented brake disk 1 is composed of a friction ring 2 prefabricated from cast iron and a carrier part 3 consisting of an aluminum cast alloy cast onto the friction ring 2, which is connected in positive fit to the friction ring 2 and oriented co-axially to this.

The friction ring 2 has in each case on its mutually opposed face sides, in an inherently known manner, annular friction surfaces 4, 5, on which the brake linings of a disk brake device, not shown, of a passenger car take effect.

Molded at regular angle intervals in the friction ring 2, between the face surfaces 4, 5, extending radially, are ventilation channels 6, 7, which are separated from one another by a wall 8, 9, consisting of the material of the friction ring 2 and likewise extending radially.

The walls 9 delimiting every fourth ventilation channel 7 merge into a projection 10, which projects on the inner side I of the friction ring 2, defining the ring aperture 11, in the direction of the axis of rotation A of the brake disk 1. With the brake disk 1, in this manner twelve trunnion-like projections 10 are formed on the friction ring 2, divided at regular angle intervals around the axis of rotation A.

Formed in each of the projections 10 is a passage channel 12, which extends coaxially to the longitudinal axis L of the individual projection 10 and merges steplessly into that ventilation channel 7 which is delimited to the side by the walls 9 of the brake disk 1 connecting to the individual projection 10. The mouth opening 12′ of the passage channel 12 is located in each case on the free face surface 10′ of the projections 10.

Each of the projections 10 has an end section 13, on which a circumferential projecting shoulder 14 is formed by material-removing machining. The circumferential surface of the shoulder 14 of the projections 10 in consequence in each case has a perfect cylindrical shape. Outside their end section 13, the projections 10 have an elliptical shape in the section transverse to their longitudinal axis L. In this situation, the projections 10 taper, starting from their base 15 arranged in the individual walls 9 in the direction of their free projecting end section 13. The widened base in combination with the elliptical cross-sectional shape guarantee a particularly high resistance of the projections 10 to the mechanical loads imposed on them during a braking procedure.

It is to be borne in mind that in the present case both the number of the ventilation channels 6, 7, as well as the corresponding number of the walls 8, 9, and the number of projections 10, are to be understood purely as examples, since the number of projections 10 selected specifically in each case depends on the loading which in fact occurs during a braking procedure. Accordingly, in practice the number and dimensioning of the ventilation channels 6 arranged between the ventilation channels 7 merging into the passage channels 12 of the projections 10 are selected in accordance with the heat to be dissipated during a braking procedure, as well as in accordance with the mechanical loads of the friction ring 2 arising in this situation. With a view to the greatest possible weight reduction, the attempt is made in principle in this situation for the number of projections 10 to be kept as low as possible. It may serve the same purpose if the ventilation channels 6, 7 are designed to be as large as possible and the thickness of the walls 8, 9 delimiting them to the side to be designed as thin as possible.

To optimize the inlet and outlet of air in the ventilation channels 6, a groove 16 is formed in each case into the surface sections of the inner side 1 of the friction ring 2, between the projections 10, into which the ventilation channels 6 merge with their inside mouth apertures.

The carrier part 3 is designed in the shape of a pot and has a circular, central retaining section 17, aligned normally in relation to the axis of rotation A, into which are introduced openings, not visible here, for the passage of securing screws. Around the retaining section 17 runs a circumferential wall 18, of which the wall thickness Du amounts to only a small fraction of the thickness Db of the brake disk 1.

Formed in the circumferential wall 18 are cut-outs 19, at angle intervals which correspond to the angle intervals of the projections 10. Each of the cut-outs 19 in this situation is surrounded by a sleeve 20, which are cast into the cast aluminum material of the carrier part 3. The sleeves 20 in this situation are made of a steel material, the resistance of which to mechanical loads is many times higher than the load resistance of the Al-material from which the carrier part 3 is cast. With their face sides facing the friction ring 2, the sleeves 20 are oriented flush to the outer surface 21 of the circumferential wall 18, while on the inner side of the carrier part 3 they project by a small over-dimension in the direction of the axis of rotation A above the inner surface 22 of the circumferential wall 18.

The end sections 13 of the projections 10 with their shoulders 14 extend in the cut-outs 19 surrounded by the sleeves 20. The height of the shoulders 14 corresponds in this situation to at least the thickness of the sleeves 20, such that the free face surfaces 10′ in the cold state are arranged in each case at least flush to the inside face surface of the sleeves 20 of the carrier part 3. The outer diameter of the shoulders 14 of the projections 10 is at the most the same as the inner diameter of the cut-outs 19, such that the projections 10 engage with their end sections 13 as far as possible free of play and essentially in positive fit into the cut-out 19 allocated to them.

When in practical operation the friction ring 2 is heated, it can therefore expand unimpeded in the radial direction. At the same time, due to the fact that ventilation channels 6, 7 are distributed over the entire circumference of the friction ring 2, it is ensured that the heat produced during a braking procedure is rapidly and uniformly dissipated from the friction ring 2. Due to the fact that, likewise, air can flow through the ventilation channels 7 connected to the passage channels 12 of the projections 10, it is ensured that no overheating occurs in the area of the coupling of the friction ring 2 to the carrier part 3.

For the manufacture of the brake disk 1, firstly the friction ring 2 with its projections 10, the passage channels 12 and the ventilation channels 6, 7 is cast from cast iron material. Next, the shoulders 14 are created on the end sections 13 of the projections 10 by means of a machining procedure with the removal of material.

The sleeves 20 are then placed onto the finished machined shoulders 14 of the projections 10. The friction ring 2 prepared in this manner is then laid in the casting mold, not shown here, in which the carrier part 3 is then cast to the friction ring 2. The Al cast material of the carrier part 3 in this situation surrounds the sleeves 20, such that, after solidification, these are held securely in the carrier part 3. Due to the fact that the sleeves 20 are located on the projections 10 during the casting of the carrier part 3, it is guaranteed in a simple manner that the sleeves 20 are positioned perfectly correctly in the finished carrier part 3.

### REFERENCE SYMBOLS

1 Brake disk
2 Friction ring
3 Carrier part
4,5 Friction surfaces of the friction ring 2
6,7 Ventilation channels
8,9 Walls delimiting the ventilation channels 6, 7 to the side
10 Projections
10′ Face surface of the individual projection 10
11 Annular aperture
12 Passage channel
12′ Mouth opening of the individual passage channel 12
13 End section of the individual projection 10
14 Shoulder of the individual projection 10
15 Base of the individual projection 10
16 Groove
17 Retaining section of the carrier part 3
18 Circumferential wall of the carrier part 3
19 Cut-outs
20 Sleeve
21 Outer surface of the circumferential wall 18
22 Inner surface of the circumferential wall 18
A Axis of rotation of the brake disk 1
Du Wall thickness of the circumferential wall 18
Db Thickness of the brake disk 1
I Inner side of the friction ring
L Individual longitudinal axis of projections 10

1. Brake disk for a disk brake, including a friction ring as first connection partner and a carrier part as second connection partner, wherein the first and second connection partners are connected to one another for co-rotation by radially-oriented projections, which are formed as single pieces onto one of the first and second connection partners and engage in positive fit in correspondingly shaped cut-out apertures of the respective other connection partner, wherein at least one of the radially-oriented projections has a passage channel, and at least one ventilation channel is formed in the friction ring for conducting away ambient air or for introducing ambient air into the passage channel of the at least one radially-oriented projections.

2. Brake disk according to claim 1, wherein the radially-oriented projections are formed at the friction ring.

3. Brake disk according to claim 1, wherein each of the radially-oriented projections has a passage channel.

4. Brake disk according to claim 2, wherein the cut-out apertures of the carrier part allocated to the radially-oriented projections provided with the passage channels have at least one opening for the conducting of ambient air, which is connected to the passage channel of the radially-oriented projections.

5. Brake disk according to claim 1, wherein cut-out apertures allocated to the radially-oriented projections provided with the passage channels are formed as break-through apertures.

6. Brake disk according to claim 5, wherein a free length of the at least one of the radially-oriented projections provided with the passage channel is dimensioned in such a way that the at least one radially-oriented projections concerned engage through the cut-out apertures.

7. Brake disk according to claim 6, wherein a mouth aperture of the passage channel arranged on a free face side of the radially-oriented projections facing the carrier part is arranged outside the cut-out apertures.

8. Brake disk according to claim 1, wherein the radially-oriented projections have a circular cross-section shape.

9. Brake disk according to claim 1, wherein the radially-oriented projections have an elliptical cross-section shape.

10. Brake disk according to claim 1, wherein individual passage channels of the radially-oriented projections are arranged co-axially to the longitudinal axis of the radially-oriented projections.

11. Brake disk according to claim 1, wherein the radially-oriented projections have at free end sections a circumferential shoulder with a circumferential surface formed by machining with removal of material.

12. Brake disk according to claim 1, wherein the cut-out apertures are surrounded in each case by a sleeve, cast into the one of the first and the second connection partner which has the cut-out aperture.

13. Brake disk according to claim 1, wherein the friction ring is manufactured from cast iron and the carrier part is manufactured from cast aluminum, which is cast onto the friction ring.

14. Brake disk according to claim 1, wherein the carrier part is formed in pot shape and the cut-out apertures are formed into a circumferential wall of the carrier part.
